(19) United States
(12) Patent Application Publication
(10) Pub. No.: US 2025/0086680 A1
(43) Pub. Date: Mar. 13, 2025

(54) DIRECT TO CONSUMERS SOCIAL MEDIA MARKETING PLATFORM

(71) Applicants: Joel Borgella, Port St. Lucie, FL (US); Xavier Beita, Sunny Isles, FL (US)

(72) Inventors: Joel Borgella, Port St. Lucie, FL (US); Xavier Beita, Sunny Isles, FL (US)

(21) Appl. No.: 18/884,495

(22) Filed: Sep. 13, 2024

Related U.S. Application Data
(60) Provisional application No. 63/538,276, filed on Sep. 13, 2023.

(51) Int. Cl. G06Q 30/0241; G06Q 30/0214; G06Q 30/0242; G06Q 50/00

(52) U.S. Cl. CPC G06Q 30/0277; G06Q 30/0214; G06Q 30/0244; G06Q 30/0246; G06Q 30/0276; G06Q 50/01

(57) ABSTRACT

A method for monetizing social media influence involving a system with an influencer device connected to a server, enabling influencers to interact with campaigns and advertisers is provided. The process includes receiving influencer data, allowing advertisers to set up and promote campaigns with specific parameters, and tracking influencer interactions in real-time. Audience data across social platforms is aggregated to provide comprehensive insights for advertisers. A Circle of Influence Monetization (C.O.I.M.) model extends campaign reach through influencer networks, with compensation based on engagement metrics. The system also supports boosting campaign awareness via fan walls, sharing content to external platforms, and providing real-time performance scores. It offers options for time-based or budget-based campaign types, campaign content enhancement using AI, and detailed audience reporting. Additionally, the system facilitates exclusive affiliate marketing, revenue tracking, and real-time analytics to optimize campaign visibility and ROI.

### CLAIM FOR PRIORITY

This application claims priority from a prior utility provisional application with the application No. 63/538,276 filed on Sep. 13, 2023. The entire collective teachings thereof being herein incorporated by reference.

### FIELD OF THE INVENTION

This invention generally relates to the field of digital social media marketing, more specifically, to a system and method for monetizing the influence of social media influencers through a closed-circuit, fan-based connection. The invention facilitates direct-to-consumer marketing, enabling advertisers to accurately track and measure the return on investment (ROI) from campaigns executed through social media channels, while allowing influencers to maintain control over their content and connections.

### BACKGROUND OF THE INVENTION

In recent years, the landscape of digital marketing has seen a significant shift towards the utilization of social media influencers as a primary means of engaging with consumers. Influencers, individuals who have amassed large and loyal followings on social media platforms, have become invaluable assets for brands seeking to promote their products and services in an authentic and engaging manner. However, despite the growing importance of influencer marketing, significant challenges persist for both influencers and advertisers within the current ecosystem.

Influencers currently face several limitations in monetizing their social media influence effectively. One of the primary issues is the lack of proprietary rights to their followers due to their reliance on third-party social media platforms. These platforms control the access and distribution of content, thereby limiting influencers' direct access to advertisers and reducing their ability to secure consistent and significant revenue streams. Furthermore, existing platforms provide limited opportunities for influencers to generate subscription-based revenue, which could otherwise offer a more stable income source.

Moreover, influencers often struggle to provide accurate and quantifiable return on investment (ROI) data to advertisers, which is critical for maintaining long-term partnerships. This lack of data hinders the maximum monetization of their follower base, as the true value of their influence remains unquantified. Additionally, follower engagement is often diluted by existing digital advertising techniques, which can result in lower overall effectiveness and reduced income for influencers.

Advertisers, on the other hand, face difficulties in effectively leveraging digital marketing through social media. The current techniques available to them often lack the precision necessary to track ROI, making it challenging to justify marketing expenditures. Advertisers also have limited access to influencers or groups of influencers, restricting their ability to target specific segments of an influencer's audience. This is further compounded by the fact that the reach of influencers is often inflated by unengaged or unvalidated followers, leading to campaigns that are less effective and costlier than anticipated.

Additionally, as social media platforms increasingly prioritize paid content, organic reach has diminished, making it harder for advertisers to achieve meaningful engagement without significant financial investment. This trend, coupled with the rise of ad-blocking technologies and the general oversaturation of social media content, has led to a decrease in the effectiveness of digital marketing efforts, further complicating the advertiser's ability to generate a positive ROI.

Given these challenges, there is a pressing need for a new system that addresses the shortcomings of existing social media marketing platforms. Such a system should enable influencers to fully monetize their social media influence by offering proprietary control over their follower base, direct access to advertisers, and the ability to generate subscription-based revenue.

### BRIEF SUMMARY OF THE INVENTION

The first aspect of the present disclosure provides a method performable in a social media marketing system comprising an influencer device communicatively connected to a server for monetizing the social media influence. The server is configured to receive influencer data comprising social media profiles, follower demographics, and engagement metrics by presenting an application interface to influencers. The server is further configured to enable advertisers to create and promote campaigns by providing campaign parameters, including mandatory social media platforms and hashtags. The server is further configured to enable influencers to participate in the campaigns by sharing, commenting, and rating on a social media-style interface. The interactions of the influencers are tracked in real-time. The server is further configured to aggregate audience data across multiple social media platforms to generate comprehensive audience insights for the advertisers. The data includes demographics, engagement rates, and social network reach. The server is further configured to utilize a Circle of Influence Monetization (C.O.I.M.) model to extend the reach of the campaigns across connected social networks. The influencers invite friends and followers to participate in the campaigns, thereby increasing engagement and the campaign reach. The server is further configured to monetize the social media influence by implementing the Circle of Influence Monetization (C.O.I.M.) model. The influencers are incentivized to extend the campaign reach by inviting their friends and the followers to engage with the campaign content. The compensation is determined based on engagement metrics, including likes, shares, comments, and video views, with payment amounts reflecting both the visibility and impact of the campaigns across the social network and the enhanced reach and engagement generated through the influencers' extended social networks.

In an embodiment, the method further includes enabling influencers to boost campaign awareness by creating posts directly on a fan wall, which are then shared with their social media followers.

In embodiments, aspects of the present invention may be referred to as FanMuse, wherein FanMuse represents the operating platform systems. FanMuse will be utilizing the Blockchain to record publisher payouts and their FanMuse score, informing the world ledger about the earning capabilities and individual influencers' ranking or rating per the FanMuse system. In addition, the publisher can choose to receive their payout/income earned via standard cash or check or via our FanMuse AltCoin. FanMuse digital coins will be provided at a higher value than the US $$ and can be used in our FanMuse marketplace. The FanMuse marketplace will allow users to purchase products and services from participating retailers and service providers.

In another embodiment, the fan wall supports infinite scrolling of the campaign content in the application interface view that enables the influencers and followers to continuously explore new campaigns.

In yet another embodiment, the method further includes enabling influencers to share campaign content to external social media accounts through the fan wall.

In yet another embodiment, the method further includes providing influencers with a real-time score based on their campaign performance, engagement, and follower interactions.

In yet another embodiment, the method further includes enabling the influencers to (i) connect with the audience across the multiple social media platforms, and (ii) monitor what campaigns their friends, family, and followers are participating in, thereby fostering community-driven engagement.

In yet another embodiment, the method further includes enabling the advertisers to promote campaigns with additional fees for higher visibility and engagement across the network.

In yet another embodiment, the method further includes enabling the advertisers to select a time-based, budget-based, or combination campaign type, optimizing the campaign based on specific objectives.

In yet another embodiment, the method further includes enabling the advertisers to embed video links within the campaign content, enabling dynamic and multimedia-rich campaigns.

In yet another embodiment, the method further includes tracking engagement metrics, comprising likes, shares, comments, video views, and calculates the influencer earnings based on their campaign performance.

In yet another embodiment, the method further includes enabling the advertisers to input instructions for campaign execution, including links to video messages or external resources.

In yet another embodiment, the method further includes providing real-time approximations of eligible influencers based on campaign type, budget, and targeting criteria.

In yet another embodiment, the method further includes enhancing campaign content based on specified prompts, such as audience preferences or trending topics using an AI model.

In yet another embodiment, the method further includes analyzing historical engagement patterns and audience behavior using the AI model to suggest optimal times for the influencers to post campaign content, thereby maximizing reach and engagement across their social media networks.

In yet another embodiment, the method further includes providing detailed reporting of the audience segmentation for the advertisers before engaging in the campaign, providing insights into potential reach and impact.

In yet another embodiment, the method further includes enabling the influencers to create exclusive affiliate marketing opportunities for their followers, including special promotions and discounts.

In yet another embodiment, the method further includes tracking the influencer revenue from various sources, including subscriptions, digital marketing, and in-app purchases, providing a comprehensive overview of earnings.

In yet another embodiment, the method further includes performing real-time analytics by continuously tracking and processing the audience engagement data from the fan wall, including interaction rates, demographic insights, and content performance, to dynamically adjust campaign visibility and targeting parameters for optimized influencer impact and advertiser return on investment (ROI).

The second aspect of the present disclosure provides a social media marketing system for monetizing the social media influence. The system includes an influencer device associated with the influencer, an advertiser device associated with an advertiser, a server and a memory communicably connected to the server and storing instructions that, when executed by the server, cause the server to: (i) receive influencer data comprising social media profiles, follower demographics, and engagement metrics by presenting an application interface to the influencers; (ii) enable advertisers to create and promote campaigns by providing campaign parameters, including mandatory social media platforms and hashtags; (iii) enable influencers to share, comment, and rate campaigns on a social media-style interface, the interactions are tracked in real-time; (iv) aggregate audience data across multiple social media platforms to generate comprehensive audience insights for advertisers, the data includes demographics, engagement rates, and social network reach; (v) utilize a Circle of Influence Monetization (C.O.I.M.) model to extend the reach of campaigns across connected social networks, the influencers invite friends and followers to participate in the campaigns, thereby increasing engagement and campaign reach; and (vi) monetize the social media influence by implementing the Circle of Influence Monetization (C.O.I.M.) model, wherein influencers are incentivized to extend campaign reach by inviting their friends and followers to engage with campaign content. The compensation is determined based on engagement metrics, including likes, shares, comments, and video views, with payment amounts reflecting both the visibility and impact of the campaigns across the social network and the enhanced reach and engagement generated through the influencers' extended social networks.

The third aspect of the present disclosure provides a non-transitory computer-readable storage medium in a social media marketing system including an influencer device communicatively connected to a server, the computer-readable storage medium storing programming instructions that, if executed by a processor in the social media marketing system, are operable to cause the social media marketing system to perform operations comprising, (i) receiving influencer data comprising social media profiles, follower demographics, and engagement metrics by presenting an application interface to influencers; (ii) enabling advertisers to create and promote campaigns by providing campaign parameters, including mandatory social media platforms and hashtags; (iii) enabling influencers to participate in the campaigns by sharing, commenting, and rating on a social media-style interface, wherein interactions of the influencers are tracked in real-time; (iv) aggregating audience data across multiple social media platforms to generate comprehensive audience insights for the advertisers, the data includes demographics, engagement rates, and social network reach; (v) utilizing a Circle of Influence Monetization (C.O.I.M.) model to extend the reach of the campaigns across connected social networks, the influencers invite friends and followers to participate in the campaigns, thereby increasing engagement and the campaign reach; and (vi) monetizing the social media influence by implementing the Circle of Influence Monetization (C.O.I.M.) model the influencers are incentivized to extend the campaign reach by inviting their friends and the followers to engage with the campaign content. The compensation is determined based on engagement metrics, including likes, shares, comments, and video views, with payment amounts reflecting both the visibility and impact of the campaigns across the social network and the enhanced reach and engagement generated through the influencers' extended social networks.

The social media marketing system is designed to enhance the monetization of social media influence by offering a comprehensive suite of tools for advertisers, influencers, publishers, and administrators. Advertisers can log in to a specialized dashboard to manage campaigns, create content with AI assistance, and track campaign performance across multiple social media platforms. The system supports multimedia integration, hashtag management, and demographic targeting, allowing advertisers to tailor their campaigns effectively. Budgeting and scheduling features enable precise control over campaign costs and timelines. Advertisers can also feature their campaigns prominently for increased visibility, while tracking mechanisms ensure genuine user engagement. By bypassing traditional social media commerce streams, the platform provides a streamlined approach to cross-platform content sharing and monetization.

The social media marketing system offers significant advantages that revolutionize the way influencers and advertisers interact with their audiences. By granting influencers complete ownership of their subscriber connections, the system eliminates reliance on third-party platforms, allowing for richer content delivery and increased follower loyalty. Advertisers gain access to highly engaged and quantifiable audiences, enabling them to target consumers with unparalleled precision. The system also provides detailed and accurate ROI data, ensuring that marketing investments are both strategic and effective. Additionally, the ability to opt into exclusive affiliate marketing opportunities further enhances the monetization potential for influencers, while fan engagement functions serve as on-demand focus groups, offering real-time feedback and optimization. Overall, the system empowers influencers to maximize their influence and offers advertisers a more reliable and impactful way to reach their target markets.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 illustrates a social media marketing system for monetizing the social media influence according to various embodiments of the present disclosure;

FIG. 2 illustrates the server hosting an AI model of FIG. 1 according to various embodiments of the present disclosure;

FIG. 3 illustrates a sample desktop interface comprising an influencer's dashboard of the system of FIG. 1 according to various embodiments of the present disclosure;

FIG. 4 illustrates a sample desktop interface comprising the fan wall of the system of FIG. 1 with a test campaign of the influencer according to various embodiments of the present disclosure;

FIG. 5 illustrates a sample interface provided by the system of FIG. 1 for tracking the performance of the influencer according to various embodiments of the present disclosure;

FIG. 6 illustrates a sample interface provided by the system of FIG. 1 for monitoring the status of any campaign participated by the influencer according to various embodiments of the present disclosure;

FIG. 7 illustrates a sample interface provided by the system of FIG. 1 for managing survey invitations for the influencers according to various embodiments of the present disclosure;

FIG. 8 illustrates a sample interface provided by the system of FIG. 1 displaying fan wall posts based on views or impressions according to various embodiments of the present disclosure;

FIG. 9 illustrates a sample interface provided by the system of FIG. 1 enabling the influencers to discover and connect with friends according to various embodiments of the present disclosure;

FIG. 10 illustrates a sample interface provided by the system of FIG. 1 including the advertiser dashboard according to various embodiments of the present disclosure;

FIG. 11 illustrates a sample interface provided by the system of FIG. 1 for creating a new campaign according to various embodiments of the present disclosure;

FIG. 12 illustrates a sample interface provided by the system of FIG. 1 for tracking and managing digital advertising campaigns according to various embodiments of the present disclosure;

FIG. 13 illustrates a sample mobile interface provided by the system of FIG. 1 with various menu options for the influencer according to various embodiments of the present disclosure;

FIGS. 14A-B are flow diagrams that illustrate a method performable in a social media marketing system comprising an influencer device communicatively connected to a server for monetizing the social media influence according to various embodiments of the present disclosure; and

FIG. 15 illustrates a general computer architecture that can be appropriately configured to implement components disclosed in accordance with various embodiments of the present disclosure.

Like reference numerals refer to like parts throughout the several views of the drawings.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. A social media marketing system for monetizing the social media influence and method thereof is discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below. The present invention will now be described by referencing the appended figures representing preferred embodiments.

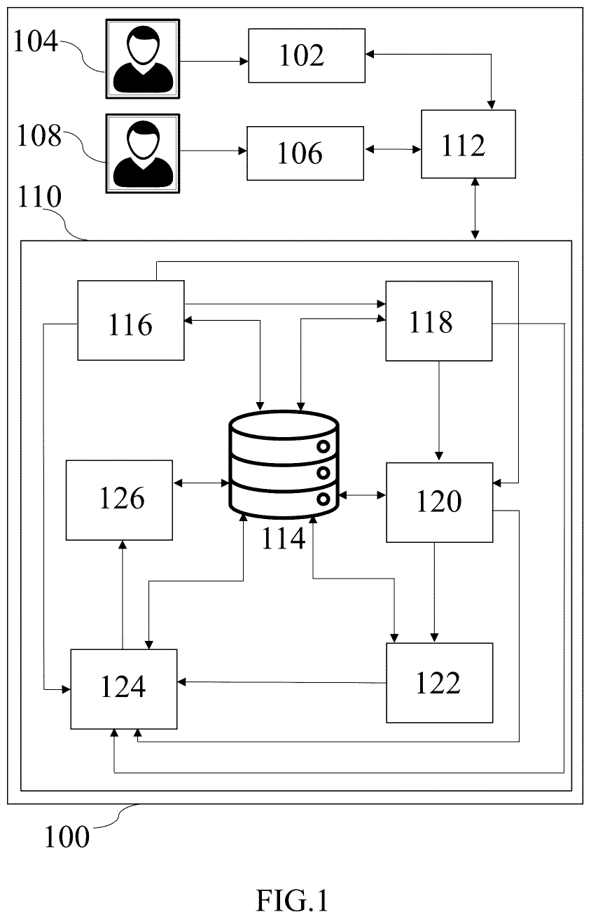

FIG. 1 illustrates a social media marketing system for monetizing the social media influence according to various embodiments of the present disclosure. The system 100 includes an influencer device 102 associated with an influencer 104, an advertiser device 106 associated with an advertiser 108, a server 110 and a communication network 112. The influencer device 102 is communicatively connected to the server 110 through the communication network 112. The server 110 includes a plurality of modules stored in a database 114. The plurality of modules of the server 110 includes a first data receiving module 116 configured to receive influencer data comprising social media profiles, follower demographics, and engagement metrics by presenting an application interface to the influencer device 102. The plurality of modules of the server 110 further includes a second data receiving module 118 configured to receive advertiser data including campaign name, campaign objective, target audience, budget allocation, demographics, duration, social media platforms, content requirements, hashtags, creative assets, target keywords, ad placement preferences and performance metrics. The plurality of modules of the server 110 further includes a real-time interactions tracking module 120 configured to track influencers' 104 comment, and rating for the campaigns on a social media-style interface. The plurality of modules of the server 110 further includes an audience data aggregation module 122 configured to aggregate audience data across multiple social media platforms to generate comprehensive audience insights for the advertiser 108. The data includes demographics, engagement rates, and social network reach. The Circle of Influence Monetization (C.O.I.M.) model 124 of the server 110 is configured to extend the reach of the campaigns by leveraging the connected social networks of the influencers 104. Through this model 124, the influencers 104 are enabled to invite their friends and followers to engage with the campaigns, thereby amplifying the campaign's visibility and effectiveness. The C.O.I.M. model 124 tracks and monetizes the influence of these connections, ensuring that influencers 104 are rewarded for their contributions to campaign success, while also driving higher levels of participation and engagement across the targeted audience. The plurality of modules of the server 110 further includes a monetization module 126 that monetize the social media influence by implementing the Circle of Influence Monetization (C.O.I.M.) model 124. The influencers 104 are incentivized to extend campaign reach by inviting their friends and followers to engage with campaign content. The compensation is determined based on engagement metrics, including likes, shares, comments, and video views, with payment amounts reflecting both the visibility and impact of the campaigns across the network and the enhanced reach and engagement generated through the influencers' 104 extended networks.

The system 100 allows influencers 104 and/or advertisers 108 to sign in or sign up using either email or social media accounts. Advertisers 108 can create detailed campaigns, including text, photo, and video content, and specify mandatory social media platforms for participation. The system 100 facilitates the advertisers 108 to make campaigns ‘featured,’ allowing them to upload a banner with specific dimensions to enhance visibility on influencers 104 fan walls. Additionally, it provides comprehensive demographic targeting options, including categories and subcategories. The system 100 also integrates a flexible interface for managing campaign invites, active campaigns, and surveys, with the ability to view and edit content, ensuring an intuitive user experience. Campaigns can be tailored to specific demographics, with filters for country, city, gender, and interests. The system 100 features a dynamic login screen with engaging visuals, a distinct separation between the campaign content and the fan wall content, and a flexible targeting mechanism that accommodates various combinations of social media platforms. Moreover, video instructions and interactive elements enhance engagement, while demographic targeting includes multiple categories and subcategories to refine audience selection. The advertisers 108 can set campaign budgets and durations, with the system 100 suggesting potential reach based on the input budget, with a maximum campaign duration of 30 days to ensure prompt results.

The system 100 provides a comprehensive social media marketing platform designed to monetize the social media influence of users, referred to as the influencers 104 or “publishers”. The system 100 provides a closed-circuit, fan-based connection via a network of mobile apps, ensuring effective marketing and brand exposure for the advertisers 108. The system 100 allows the advertisers 108 to identify and aggregate their desired audience across multiple social media platforms or specific combinations of platforms. This is done based on criteria such as demographics, interests, and engagement potential. The advertisers 108 can establish a budget for their campaigns and receive real-time metrics on reach, impressions, and engagement possibilities. These metrics are determined by the allocated budget, chosen social media platforms, and the score of the influencers 104 involved. The system 100 leverages the Circle of Influence Monetization model, which enables exponential reach of the campaigns. The influencers 104 build and engage their social network using the system 100, inviting friends, family, and followers to participate in the campaigns. This extended network enhances the campaign's visibility and effectiveness. The influencers 104 create a network of followers using the system 100 who are specifically interested in the content shared by the influencers 104. This network is used to promote campaigns, incentivize engagement, and test brand messages, creating a more authentic connection between the brand and the consumer. The system 100 incorporates AI tools to assist both the influencers 104 and the advertisers 108 in creating and enhancing their brand messages. These AI resources can generate content based on specified prompts, such as trending topics or audience preferences, and suggest optimal posting times to maximize engagement. The advertisers 108 have the ability to create and manage campaigns. This includes adding text, photos, videos, and other content specific to the fan wall. The advertisers 108 can also set mandatory social media platforms for participation, input required hashtags, and provide detailed instructions for campaign execution.

The system 100 allows the advertisers 108 to target their campaigns with high specificity, including options for geographic location, gender, marital status, parental status, education level, age range, and interest categories. This ensures that the campaign reaches the most relevant audience. The influencer 104 have access to a dashboard where they can view, accept, or reject campaign invitations. They can also track the performance of their active campaigns, view earned revenue, and share campaign content to boost engagement.

The influencer fan wall is a core feature of the system 100, where the influencer 104 share their active campaigns. Followers can see what campaigns their connections are participating in, comment, rate, and share these campaigns across their own social media networks. The infinite scroll feature ensures continuous content engagement. The influencer 104 can participate in surveys as part of the campaign process, which can increase their score and provide monetary or discount incentives. Survey participation also functions as a focus group, offering valuable feedback to the advertisers 108. The influencers 104 are rated based on their engagement and influence within the platform. The influencer's score and tier level are displayed on the dashboard, affecting their eligibility for certain campaigns and their potential earnings. The system 100 provides opportunities for in-app purchases, such as event tickets or merchandise, with a percentage of the revenue distributed among the influencers 104 and the advertisers 108. The system 100 supports seamless integration with e-commerce platforms, allowing direct product sales through social media channels. The system 100 also features automated campaign management, facilitating the scheduling, tracking, and optimization of marketing efforts. The system 100 not only monetizes social media influence but also provides a detailed, data-driven approach to digital marketing, enabling the advertisers 108 to connect with highly engaged audiences in a meaningful and measurable way.

The system 100 includes a learning center feature that serves as an educational hub for the influencers 104 and the advertisers 108 offering a curated collection of videos and resources to enhance their understanding and utilization of the system's functionality. This feature is designed to empower users with knowledge, enabling them to maximize the system's potential for engaging with followers and optimizing their social media strategies.

The system 100 focuses on leveraging the influence of social media users to create effective advertising campaigns. The system 100 matches the advertisers 108 with the influencers 104 based on their activity and engagement levels across various platforms. The advertisers 108 have the flexibility to design campaigns with specific content requirements, including hashtags and detailed instructions for the influencers 104. The system's 100 approach to targeting and budgeting ensures that the campaigns reach the desired audience while optimizing costs. The integration of a unique scoring system enhances the credibility of the influencers 104 and deters automated bots, fostering genuine interactions. Additionally, the system's 100 commitment to legal protections and compliance safeguards its innovative processes and intellectual property.

The system 100 includes anti-fraud mechanisms to ensure the authenticity of participant interactions, and a Fan Fair Rating System that allows the influencers 104 to rate and review campaigns, adding layers of credibility and transparency. The system 100 also supports automated multi-platform posting, enabling seamless distribution of content across various social media channels without manual intervention. Additionally, it provides influencer engagement tracking to monitor how influencers interact with campaigns and their audience's response. User preference analytics are also incorporated, offering valuable insights into user behaviors and preferences, which helps refine targeting strategies and optimize campaign outcomes.

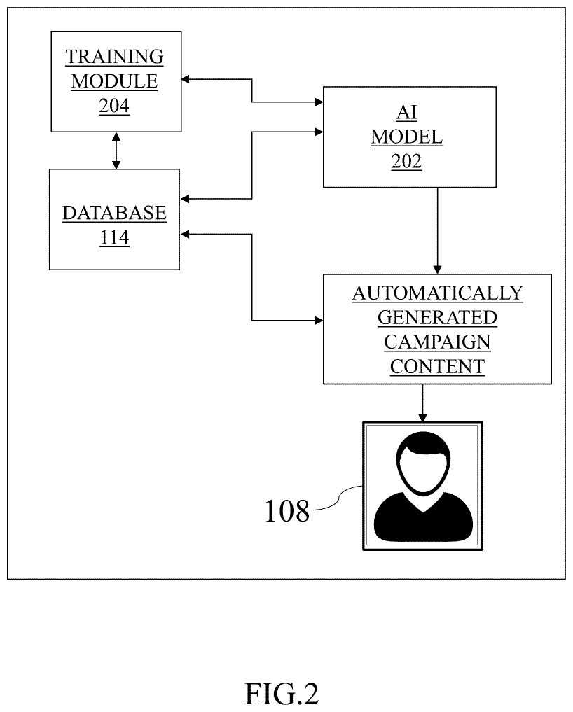

FIG. 2 illustrates the server hosting an AI model of FIG. 1 according to various embodiments of the present disclosure. The AI model 202 is trained using the training module 204. The database 114 stores the attributes for training the AI model 202. The AI model 202 generates campaign content trained on historical data, audience preferences, and trending topics. The training of the AI model 202 involves analyzing large datasets of past campaigns, audience interactions, and engagement metrics to identify patterns and preferences. The AI model 202 is then used to automatically generate content tailored to resonate with the target audience, including the selection of the tone of the content, which is adjusted based on the context of the campaign, the demographics of the audience, and the nature of the product or service being promoted. The tone may range from casual and conversational to formal and authoritative, depending on the desired impact and brand identity. The AI model 202 analyzes user engagement, identifying key influencers and optimizing content distribution across various platforms. The system 100 integrates real-time analytics and machine learning to predict trends, enabling marketers to adjust strategies dynamically.

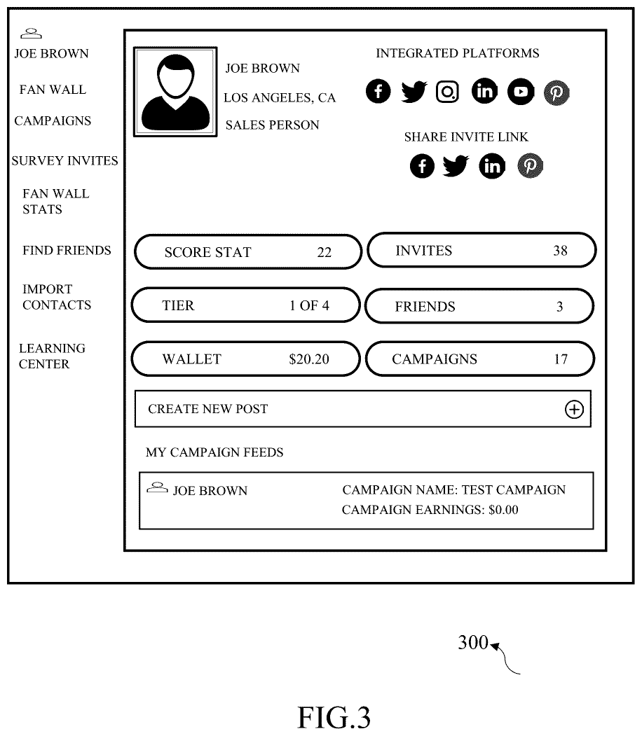

FIG. 3 illustrates a sample desktop interface comprising an influencer's dashboard of the system of FIG. 1 according to various embodiments of the present disclosure. The influencer's dashboard 300 is designed to keep the advertisers informed about their performance and opportunities. It displays the influencer's score, tier level, earned revenue (visible in their wallet), pending and active campaign invitations, and the total number of friends. The dashboard 300 also allows influencers to update their profiles, chat with their network, and promote active campaigns on the fan wall.

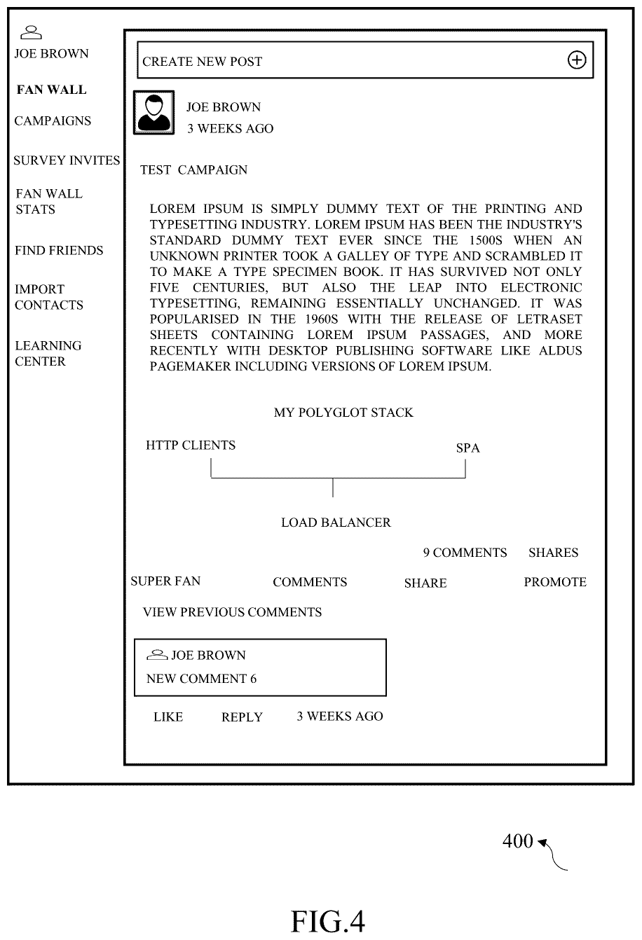

FIG. 4 illustrates a sample desktop interface comprising the fan wall of the system of FIG. 1 with a test campaign of the influencer according to various embodiments of the present disclosure. The interface 400 includes Xavier Beitia's (i.e.) influencer “Test Campaign” providing a detailed overview of a sample campaign. The campaign includes a placeholder text, commonly used to demonstrate layout and design, and references a “Polyglot Stack,” suggesting that the campaign may involve multiple technologies and programming languages. The interface is designed to showcase how the campaigns are structured including potential technologies like HTTP clients, Single Page Applications (SPA), and load balancers, giving users an idea of how content and tech stacks are integrated into campaigns.

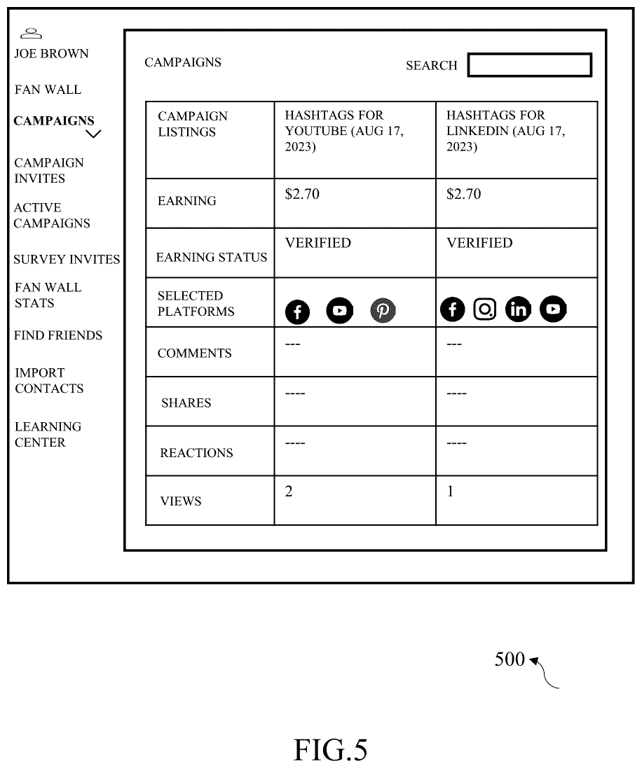

FIG. 5 illustrates a sample interface provided by the system of FIG. 1 for tracking the performance of the influencer according to various embodiments of the present disclosure. The interface 500 shows whether the influencer has earned any money, confirms if they've correctly executed the campaign tasks, and indicates whether those tasks have been submitted for verification. This summary allows influencers to manage their progress and ensure all campaign requirements are met before finalizing their participation.

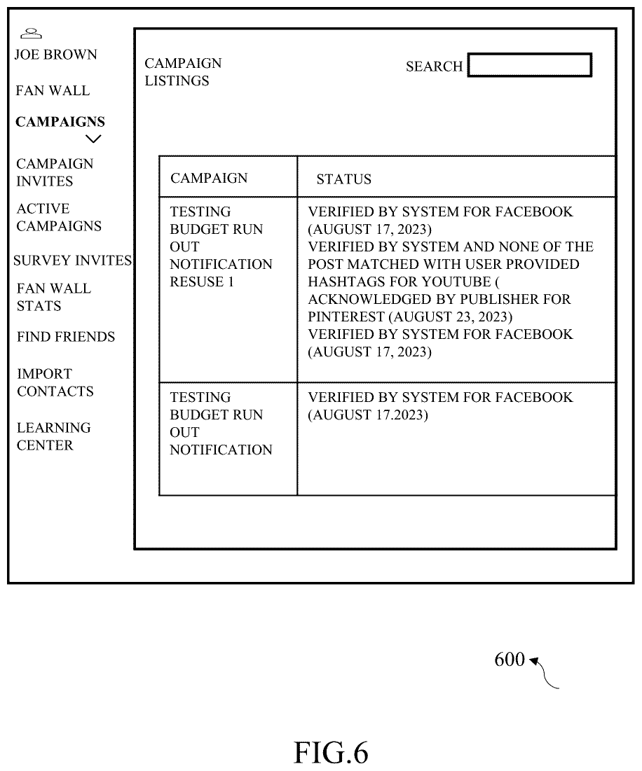

FIG. 6 illustrates a sample interface provided by the system of FIG. 1 for monitoring the status of any campaign participated by the influencer according to various embodiments of the present disclosure. The interface 600 allows to monitor the status of any campaign participated by the influencer. It provides real-time updates on the progress, including whether tasks have been completed, what steps remain, and if any issues need to be addressed. This helps ensure the influencer is on track with campaign goals and can verify that everything is running smoothly.

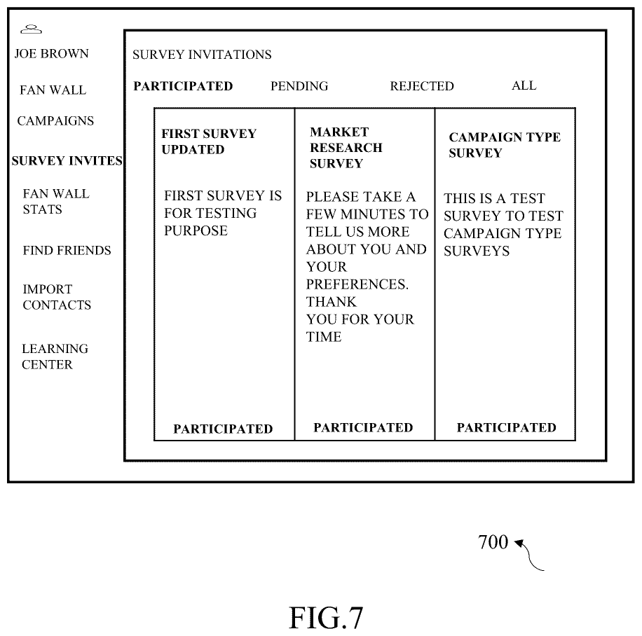

FIG. 7 illustrates a sample interface provided by the system of FIG. 1 for managing survey invitations for the influencers according to various embodiments of the present disclosure. The interface 700 facilitates managing survey invitations for the influencers. Here, the influencers can view all the surveys they've been invited to and decide whether to accept or reject them. Each survey's requirements and incentives, such as monetary rewards, coupon codes, or score boosts, are clearly displayed. Once a survey is accepted, the influencer can start answering the questions directly from this screen, making it a streamlined process for participation and reward collection.

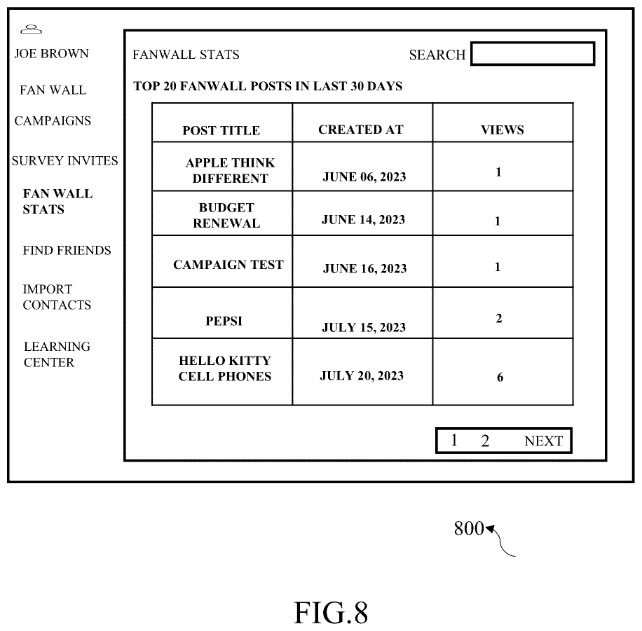

FIG. 8 illustrates a sample interface provided by the system of FIG. 1 displaying fan wall posts based on views or impressions according to various embodiments of the present disclosure. The interface 800 displays the top 20 fan wall posts from the last 30 days based on the views or impressions. The table shown includes columns for the post title, the date each post was created, and the number of views each post received. This section allows the influencers to gauge the popularity and engagement of their posts on their fan wall, helping them track which content resonates most with their audience.

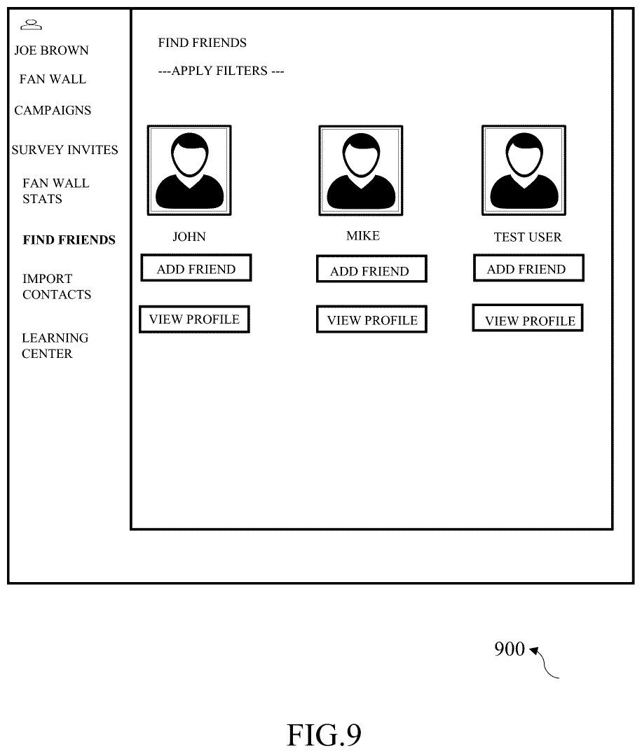

FIG. 9 illustrates a sample interface provided by the system of FIG. 1 enabling the influencers to discover and connect with friends according to various embodiments of the present disclosure. The interface 900 allows the influencers to discover and connect with friends who are part of their social circles, both in the physical world and across various social media platforms. By linking multiple social media accounts, the system identifies mutual connections and suggest friends who may already be known across different networks. This feature enhances the system's effectiveness, enabling the advertisers to reach the influencer's entire network of influence, both digitally and physically, for more targeted and impactful campaigns.

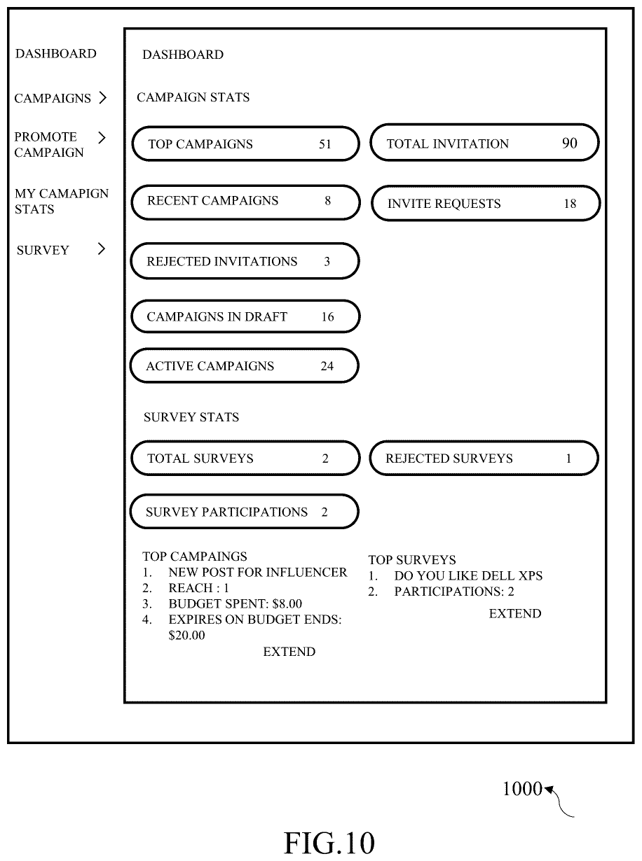

FIG. 10 illustrates a sample interface provided by the system of FIG. 1 including the advertiser dashboard according to various embodiments of the present disclosure. The interface 1000 including the advertiser dashboard is the main interface advertisers see upon logging in. The dashboard layout provides a clear overview of active and draft campaigns, surveys, and participation rates. A panel highlights the top-performing campaigns and surveys offering insights into the most successful engagements. This layout ensures advertisers to easily manage and track their campaigns.

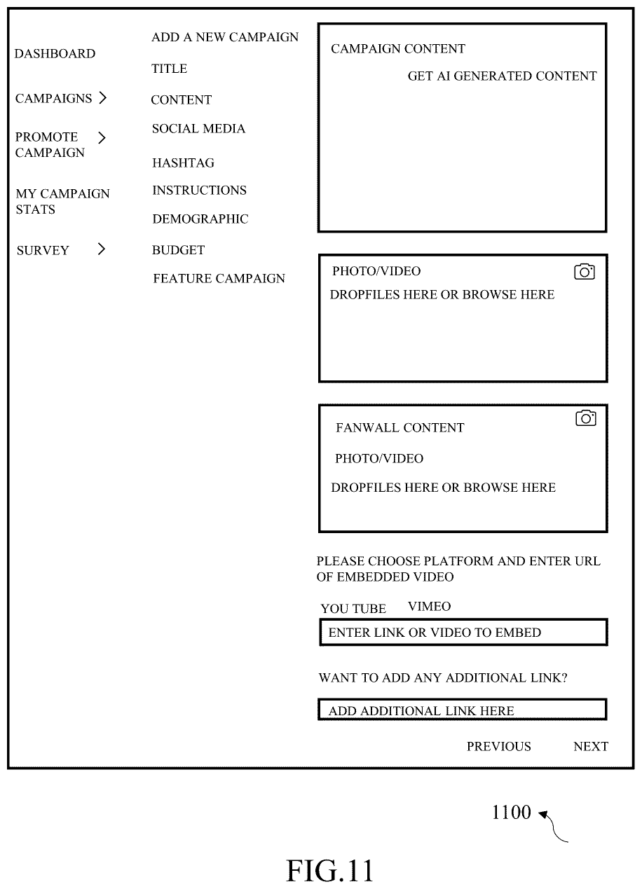

FIG. 11 illustrates a sample interface provided by the system of FIG. 1 for creating a new campaign according to various embodiments of the present disclosure. The interface 1100 facilitates advertisers to craft campaigns to be shared. The interface 1100 allows the advertisers to add various types of content, including text, photos, and videos, specifically tailored for the fan wall. Additionally, the advertisers can include embedded video links to enhance their campaigns. This feature-rich section provides all the necessary tools for advertisers to create compelling and engaging content that resonates with their target audience.

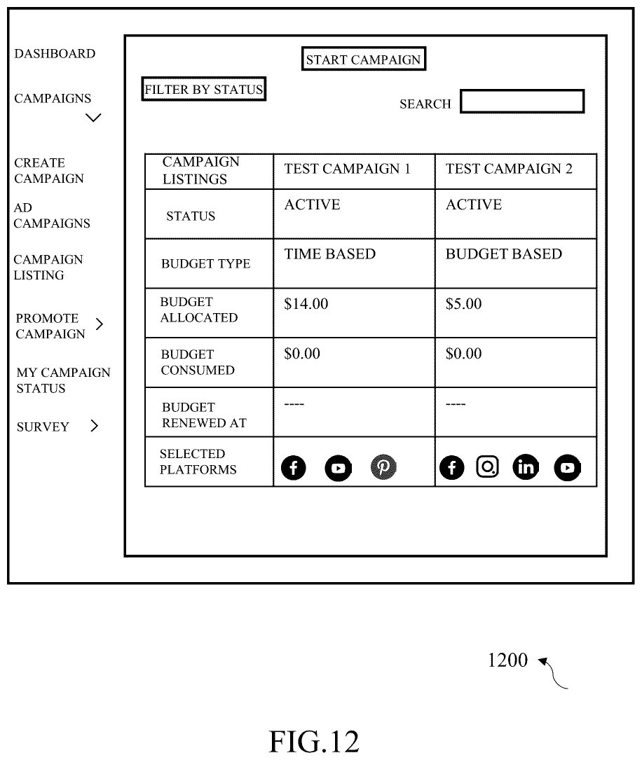

FIG. 12 illustrates a sample interface provided by the system of FIG. 1 for tracking and managing digital advertising campaigns according to various embodiments of the present disclosure. The interface 1200 provides a comprehensive overview of ongoing and past campaigns, displaying key metrics such as campaign status, budget allocation, and consumption. The advertisers can easily filter and search campaigns, view detailed information, and access tools for editing or deleting campaigns. Additionally, the interface 1200 highlights the platforms where the campaigns are active, helping users efficiently monitor their performance and make informed decisions to optimize budget utilization and achieve campaign goals.

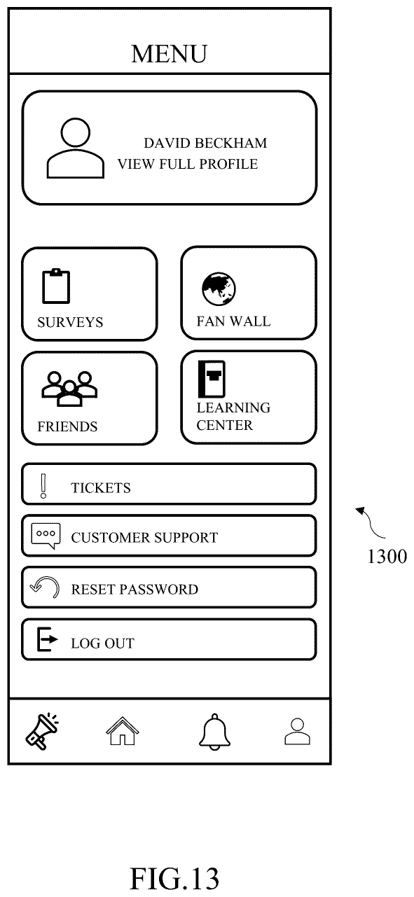

FIG. 13 illustrates a sample mobile interface provided by the system of FIG. 1 with various menu options for the influencer according to various embodiments of the present disclosure. The interface 1300 prominently displays the interface's profile information, along with a menu of options for accessing key features of the application. These options include participating in surveys, interacting with the fan community, managing friends, and accessing the learning center. Additionally, the interface 1300 provides essential support tools, such as ticket submission, customer support, password reset, and logout functions. The bottom navigation bar further enhances user experience by offering quick access to the home screen, notifications, and profile settings, thereby streamlining the user's interaction with the application.

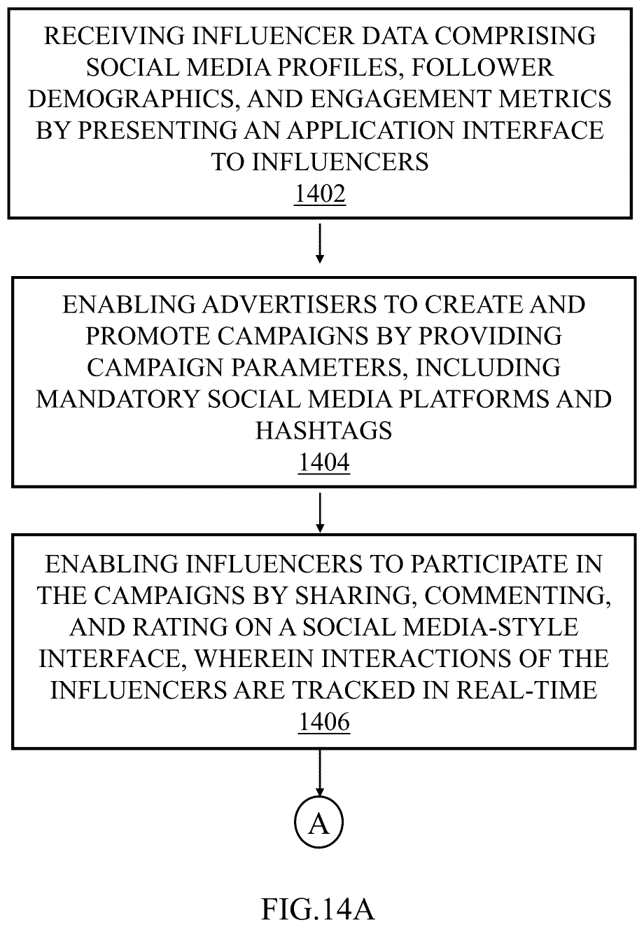

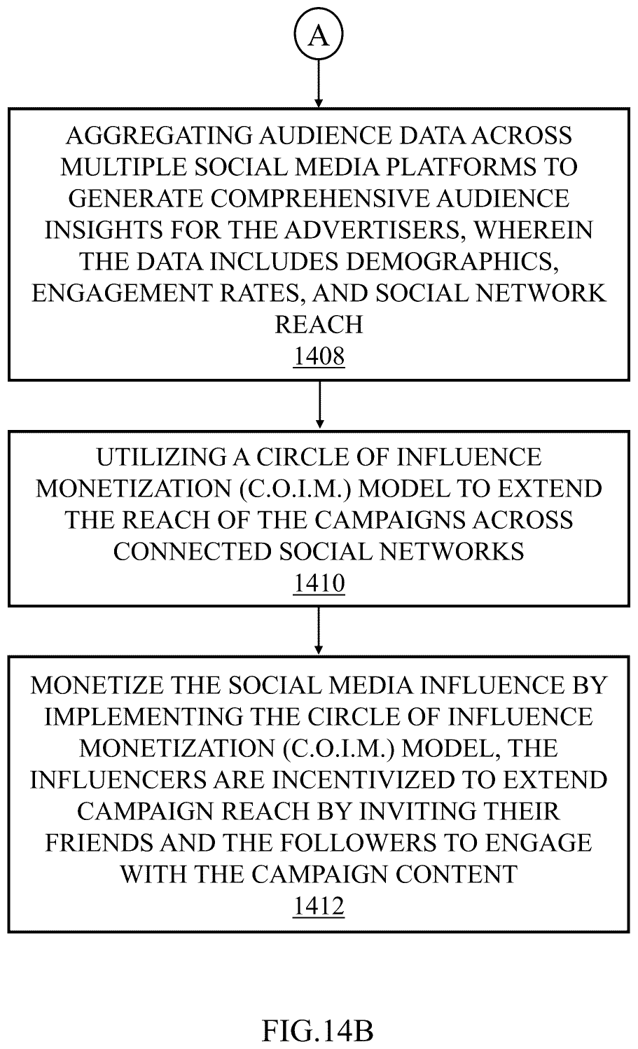

FIGS. 14A-B are flow diagrams that illustrate a method performable in a social media marketing system comprising an influencer device communicatively connected to a server for monetizing the social media influence according to various embodiments of the present disclosure. The method includes at step 1402, receiving influencer data comprising social media profiles, follower demographics, and engagement metrics by presenting an application interface to influencers. The method includes at step 1404, enabling advertisers to create and promote campaigns by providing campaign parameters, including mandatory social media platforms and hashtags. The method includes at step 1406, enabling influencers to share, comment, and rate campaigns on a social media-style interface, wherein interactions of the influencers are tracked in real-time. The method includes at step 1408, aggregating audience data across multiple social media platforms to generate comprehensive audience insights for the advertisers. The data includes demographics, engagement rates, and social network reach. The method includes at step 1410, utilizing a Circle of Influence Monetization (C.O.I.M.) model to extend the reach of the campaigns across connected social networks. The influencers invite friends and followers to participate in the campaigns, thereby increasing engagement and campaign reach. The method includes at step 1412, monetize the social media influence by implementing the Circle of Influence Monetization (C.O.I.M.) model. The influencers are incentivized to extend campaign reach by inviting their friends and the followers to engage with the campaign content. The compensation is determined based on engagement metrics, including likes, shares, comments, and video views, with payment amounts reflecting both the visibility and impact of the campaigns across the social network and the enhanced reach and engagement generated through the influencers' extended social networks.

The process flow begins when the influencer accepts an invitation, initiating their participation. The next critical step is for the influencer to both share and acknowledge the designated posts. If these actions are completed, the process advances to the “Submit for review and payment” stage. At this point, a manual verification is conducted using tags to ensure that the task has been properly executed. Upon successful verification, the final step involves approving the payment, thereby completing the workflow. This structured approach ensures that each step is thoroughly checked before the payment is processed.

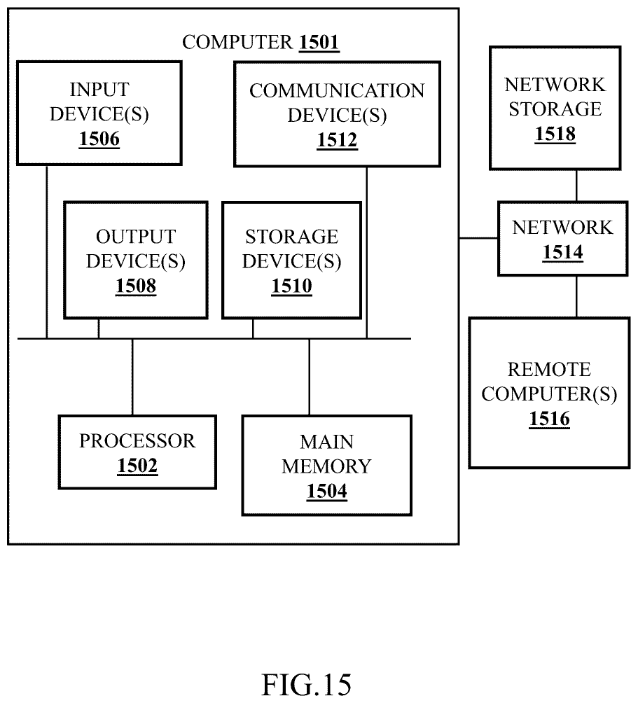

FIG. 15 illustrates a general computer architecture that can be appropriately configured to implement components disclosed in accordance with various embodiments of the present disclosure. The general computing architecture 1500 can include various common computing elements, such as a computer 1501, a network 1514, and one or more remote computers 1516. The computer 1501 may be a server, a desktop computer, a laptop computer, a tablet computer or a mobile computing device. The computer 1501 may include a processor 1502, a main memory 1504 and a system bus. The processor 1502 may feature one or more processing units that can operate independently of each other. The main memory 1504 may include volatile devices, non-volatile devices, or other random access memory devices. The computer 1501 may feature secondary storage 1510, consisting of one or more removable and/or non-removable storage units. These units house an operating system that manages various applications on the computer 1501. The secondary storage 1510 may also be used to store software configured to implement the components of the embodiments disclosed herein, which may be executed as one or more applications under the operating system. The computer 1501 may also include a communication device(s) 1512 through which the computer communicates with other devices, such as one or more remote computers 1516, over wired and/or wireless computer networks 1514. The communication device(s) 1512 may communicate over but not limited to Wi-Fi, Bluetooth, ultra-wide band technology, and mobile telephone networks. The computer 1501 may also access network storage 1518 through computer network 1514. The network storage 1518 may include a network-attached storage device or cloud-based storage. The operating system and/or software may be stored in network storage 1518. The computer 1501 may have various input device(s) 1506 for example, keyboard, mouse, touchscreen, camera, microphone, or a sensor, output device(s) 1508, for example, a display, speakers or a printer. Storage devices 1510, the communication device(s) 1512, input devices 1506 and output devices 1508 may be integrated within a computer system or connected through various computer input/output interface devices.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention. While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention. In some embodiments, the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

The present invention has been described with reference to the preferred embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

What is claimed is:

1. A method performable in a social media marketing system comprising an influencer device communicatively connected to a server for monetizing the social media influence, comprising:
receiving influencer data comprising social media profiles, follower demographics, and engagement metrics by presenting an application interface to influencers;
enabling advertisers to create and promote campaigns by providing campaign parameters, including mandatory social media platforms and hashtags;
enabling influencers to participate in the campaigns by sharing, commenting, and rating on a social media-style interface, wherein interactions of the influencers are tracked in real-time;
aggregating audience data across multiple social media platforms to generate comprehensive audience insights for the advertisers, wherein the data includes demographics, engagement rates, and social network reach;
utilizing a Circle of Influence Monetization (C.O.I.M.) model to extend the reach of the campaigns across connected social networks, wherein the influencers invite friends and followers to participate in the campaigns, thereby increasing engagement and the campaign reach; and
monetizing the social media influence by implementing the Circle of Influence Monetization (C.O.I.M.) model, wherein the influencers are incentivized to extend the campaign reach by inviting their friends and the followers to engage with the campaign content, wherein compensation is determined based on engagement metrics, including likes, shares, comments, and video views, with payment amounts reflecting both the visibility and impact of the campaigns across the social network and the enhanced reach and engagement generated through the influencers' extended social networks.

2. The method of claim 1, wherein the method further comprises enabling influencers to boost campaign awareness by creating posts directly on a fan wall, which are then shared with their social media followers.

3. The method of claim 2, wherein the fan wall supports infinite scrolling of the campaign content in the application interface view that enables the influencers and followers to continuously explore new campaigns.

4. The method of claim 2, wherein the method further comprises enabling influencers to share campaign content to external social media accounts through the fan wall.

5. The method of claim 1, wherein the method further comprises providing influencers with a real-time score based on their campaign performance, engagement, and follower interactions.

6. The method of claim 1, wherein method further comprises enabling the influencers to (i) connect with the audience across the multiple social media platforms, and (ii) monitor what campaigns their friends, family, and followers are participating in, thereby fostering community-driven engagement.

7. The method of claim 1, wherein the method further comprises enabling the advertisers to promote campaigns with additional fees for higher visibility and engagement across the network.

8. The method of claim 1, wherein the method further comprises enabling the advertisers to select a time-based, budget-based, or combination campaign type, optimizing the campaign based on specific objectives.

9. The method of claim 1, wherein the method further comprises enabling the advertisers to embed video links within the campaign content, enabling dynamic and multimedia-rich campaigns.

10. The method of claim 1, wherein the method further comprises tracking engagement metrics, comprising likes, shares, comments, video views, and calculates the influencer earnings based on their campaign performance.

11. The method of claim 1, wherein the method further comprises enabling advertisers to input instructions for campaign execution, including links to video messages or external resources.

12. The method of claim 1, wherein the method further comprises providing real-time approximations of eligible influencers based on campaign type, budget, and targeting criteria.

13. The method of claim 1, wherein the method further comprises enhancing campaign content based on specified prompts, such as audience preferences or trending topics using an AI model.

14. The method of claim 13, wherein the method further comprises analyzing historical engagement patterns and audience behavior using the AI model to suggest optimal times for the influencers to post campaign content, thereby maximizing reach and engagement across their social media networks.

15. The method of claim 1, wherein the method further comprises providing detailed reporting of the audience segmentation for the advertisers before engaging in the campaign, providing insights into potential reach and impact.

16. The method of claim 1, wherein the method further comprises enabling the influencers to create exclusive affiliate marketing opportunities for their followers, including special promotions and discounts.

17. The method of claim 1, wherein the method further comprises tracking the influencer revenue from various sources, including subscriptions, digital marketing, and in-app purchases, providing a comprehensive overview of earnings.

18. The method of claim 1, wherein the method further comprises performing real-time analytics by continuously tracking and processing the audience engagement data from the fan wall, including interaction rates, demographic insights, and content performance, to dynamically adjust campaign visibility and targeting parameters for optimized influencer impact and advertiser return on investment (ROI).

19. A social media marketing system for monetizing the social media influence, wherein the system comprises:
an influencer device associated with the influencer;
an advertiser device associated with an advertiser;
a server; and
a memory communicably connected to the server and storing instructions that, when executed by the server, cause the server to:
receive influencer data comprising social media profiles, follower demographics, and engagement metrics by presenting an application interface to influencers;
enable advertisers to create and promote campaigns by providing campaign parameters, including mandatory social media platforms and hashtags;
enable influencers to participate in the campaigns by sharing, commenting, and rating on a social media-style interface, wherein interactions of the influencers are tracked in real-time;
aggregate audience data across multiple social media platforms to generate comprehensive audience insights for the advertisers, wherein the data includes demographics, engagement rates, and social network reach;
utilize a Circle of Influence Monetization (C.O.I.M.) model to extend the reach of the campaigns across connected social networks, wherein the influencers invite friends and followers to participate in the campaigns, thereby increasing engagement and the campaign reach; and
monetize the social media influence by implementing the Circle of Influence Monetization (C.O.I.M.) model, wherein the influencers are incentivized to extend the campaign reach by inviting their friends and the followers to engage with the campaign content, wherein compensation is determined based on engagement metrics, including likes, shares, comments, and video views, with payment amounts reflecting both the visibility and impact of the campaigns across the social network and the enhanced reach and engagement generated through the influencers' extended social networks.

20. A non-transitory computer-readable storage medium in a social media marketing system comprising an influencer device communicatively connected to a server, the computer-readable storage medium storing programming instructions that, if executed by a processor in the social media marketing system, are operable to cause the social media marketing system to perform operations comprising,
receiving influencer data comprising social media profiles, follower demographics, and engagement metrics by presenting an application interface to influencers;
enabling advertisers to create and promote campaigns by providing campaign parameters, including mandatory social media platforms and hashtags;
enabling influencers to participate in the campaigns by sharing, commenting, and rating on a social media-style interface, wherein interactions of the influencers are tracked in real-time;
aggregating audience data across multiple social media platforms to generate comprehensive audience insights for the advertisers, wherein the data includes demographics, engagement rates, and social network reach;
utilizing a Circle of Influence Monetization (C.O.I.M.) model to extend the reach of the campaigns across connected social networks, wherein the influencers invite friends and followers to participate in the campaigns, thereby increasing engagement and the campaign reach; and
monetizing the social media influence by implementing the Circle of Influence Monetization (C.O.I.M.) model, wherein the influencers are incentivized to extend the campaign reach by inviting their friends and the followers to engage with the campaign content, wherein compensation is determined based on engagement metrics, including likes, shares, comments, and video views, with payment amounts reflecting both the visibility and impact of the campaigns across the social network and the enhanced reach and engagement generated through the influencers' extended social networks.
